(19) United States
(12) Patent Application Publication
(10) Pub. No.: US 2007/0258428 A1
(43) Pub. Date: Nov. 8, 2007

(54) METHOD AND APPARATUS FOR COORDINATING TIMING IN A WIRELESS LOCAL AREA NETWORK

(75) Inventors: Juan Carlos Zuniga, Montreal (CA); Marian Rudolf, Montreal (CA); Joseph A. Kwak, Bolingbrook, IL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/738,119

(22) Filed: Apr. 20, 2007

Related U.S. Application Data
(60) Provisional application No. 60/794,463, filed on Apr. 24, 2006.

(51) Int. Cl. H04Q 7/24

(52) U.S. Cl. 370/338

(57) ABSTRACT

In a wireless communication system including a (STA) including a basic service set (BSS) timer and in communication with a mesh access point (MAP), and a network management (NM) entity wherein the MAP and NM entity include a mesh timer, a method and apparatus for coordinating timing comprises the STA transmitting a BSS timer information message to the MAP, wherein the BSS timer information message includes a BSS timer value. The MAP receives the BSS timer information message and modifies the message. The MAP forwards the modified message to the NM entity.

### CROSS REFERENCE TO RELATED APPLICATION

This application claims the benefit of U.S. Provisional Application Ser. No. 60/794,463, filed Apr. 24, 2006, which is incorporated herein by reference as if fully set forth.

### FIELD OF INVENTION

The present invention is related to timing in a wireless local area network (WLAN). More particularly, the present invention is related to a method and apparatus for coordinating timing in a WLAN.

### BACKGROUND

The 802.11s standard provides a means to form a mesh wireless backhaul with 802.11 wireless local area network (WLAN) technology. Mesh networks are also known as multi-hop networks, since packets might be relayed more than once in order to reach their destination. This provides a different paradigm as compared to the original WLAN standard, which addressed only star topologies for stations (STAs) to be connected to an access point (AP) effectively using single hop communications through a basic service set (BSS). The original WLAN paradigm may also be referred to as “infra-structure mode.”

The 802.11s standard, though, only addresses the scenario where the network-side nodes form a mesh network, and where WLAN mesh operation in the backhaul is transparent to all STAs. This means that, similar to legacy 802.11 WLAN networks, STAs still connect to an AP through a BSS. A mesh-capable AP, referred to as a mesh AP (MAP), interfaces on its “backhaul” side to other mesh points (MPs), which forward and route traffic through the WLAN backhaul mesh to its destination. The destination can be either a mesh portal which may connect the wireless mesh segment to a wired LAN segment, or it can be another MAP attached to the mesh network. In this manner, legacy STAs can operate in WLAN mesh-enabled backhaul networks. Essentially, an MAP functions similarly to a typical AP to serve STAs in its BSS and as a wireless bridge, or MP, to receive, forward and route packets through the backhaul mesh.

In existing art 802.11 technology, STAs synchronize with the AP by adjusting their internal timers to the beacon frame sent in regular intervals by the AP. The AP therefore constitutes the timing reference for all STAs in its BSS. This communication process between STAs and the AP in the BSS is completely independent of the mesh, and therefore STAs are typically not aware of the presence of a mesh network in the backhaul.

The BSS, through the AP, synchronizes all STAs to a common clock and timer through the use of the beacon frames. This common BSS timer value is often used as a timestamp or reference time interval by STAs when reporting events and measurements to the AP or by the AP when applying actions to change radio settings in the STAs or the BSS. Some of these actions and features are provided in the IEEE 802.11h, k and v amendments. For example, all of the measurements used for DFS and regulatory radar avoidance, such as Basic Request, CCA Request, RPI Histogram Request, and the like, specify a start time for each measurement. All 802.11 measurement reports, such as RPI Histogram Report, Beacon Report, Channel Load Report, and the like, include an actual start time information element (IE) and a measurement duration IE so that the report recipient may know when the measurement was made.

Similarly, mesh nodes forming the mesh network may synchronize among themselves using a common clock. When MPs work with a common clock, they are referred to as synchronizing MPs. When the “Synchronized with peer MP” bit in the “Synchronization Capability” field of the WLAN Mesh Capability element is set to 1, it indicates that the MP is currently a synchronizing MP. The timer used by the AP in the BSS and the timers used in the mesh are not necessarily the same. Therefore, as currently amended, the 802.11s draft amendment includes a mechanism where a synchronizing MAP communicates its timer offset (that is, BSS clock compared to mesh clock) at least to its tier-1 neighbor nodes to circumvent limitations for the MAP when communicating with its tier-1 neighbors. This information is included in the beacon timing element. The beacon timing element is used by a synchronizing MP to advertise an offset between its self TSF and the Mesh TSF, and to advertise the beacon timing information of zero or more of its MP neighbors.

FIG. 1 shows a wireless communication system 100 containing a WLAN mesh network and a plurality of BSSs. The WLAN mesh network includes a plurality of MAPs 120, mesh nodes (MPs) 110, and at least one gateway node 130. A mesh timer is associated with the mesh WLAN. In addition, each MAP 120 is also part of a BSS (designated BSS1, BSS2, BSS3, and BSS4), each of which include a BSS timer (Timer 1, Timer 2, Timer 3, and Timer 4, respectively). The BSSs also may include STAs 140. In the present example, BSS1 contains one STA 140, BSS2 contains no STAs 140, BSS3 contains two STAs 140, and BSS4 contains one STA 140. It should be noted that any number of STAs 140 may be included in any BSS. The STAs 140 are in wireless communication with their associated MAP 120 of their BSS.

Currently, there is no mechanism where a timing value reported by a STA in its BSS to the associated MAP and forwarded to a network-based Network Manager (NM) is translated into a timing value that is also meaningful to the remote NM. Because the remote NM is not knowledgeable about the BSS timing values used by the STAs when connected through a mesh, unless the NM is residing on one of the tier-1 mesh neighbors, the NM is unable to utilize the timing information.

Accordingly, this limits the usefulness of existing signaling procedures when collecting radio measurements from STAs or when trying to coordinate changes in radio settings through the AP for STAs in the BSS. Effectively, this limits implementation of such radio measurement or radio management functionality to the AP itself. Additionally, in wired WLAN backhaul networks, the most prominent implementations favor centralized network management functionality for both cost and performance reasons.

Therefore, it would be advantageous to translate BSS timing values into mesh timing values in order to enable implementation of network management functionality through 802.11s-enabled WLAN mesh backhauls.

### SUMMARY

The present invention is related to a method and apparatus for coordinating timing in a wireless communication system that includes a (STA) including a basic service set (BSS) timer in communication with a mesh access point (MAP), and a network management (NM) entity wherein the MAP and NM entity include a mesh timer. The STA transmits a BSS timer information message to the MAP, wherein the BSS timer information message includes a BSS timer value. The MAP receives the BSS timer information message and modifies the message. The MAP forwards the modified message to the NM entity.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a wireless communication system containing a wireless local area network (WLAN) mesh network and a plurality of basic service sets (BSSs);

FIG. 2 is a functional block diagram of a wireless transmit/receive unit (WTRU) configured to coordinate timing in the WLAN mesh network of FIG. 1 in accordance with the present invention;

FIG. 3 shows a wireless communication system containing a WILAN mesh network and a plurality BSSs performing a method for coordinating timing in the wireless communication system of FIG. 1;

FIG. 4 is an exemplary signal diagram of a station (STA), mesh access point (MAP), mesh point (MP) and mesh portal performing a method for coordinating timing in the wireless communication system of FIG. 3;

FIG. 5 is a flow diagram of performing a method for coordinating timing in the wireless communication system of FIG. 3;

FIG. 6 is an exemplary signal diagram of a STA, MAP, MP and mesh portal performing a method for coordinating timing in the wireless communication system of FIG. 3, in accordance with another embodiment of the present invention; and

FIG. 7 is an exemplary signal diagram of a STA, MAP, MP and mesh portal performing a method for coordinating timing in the wireless communication system of FIG. 3, in accordance with another embodiment of the present invention.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is directed to a method and apparatus for coordinating timing in wireless local area networks (WLANs).

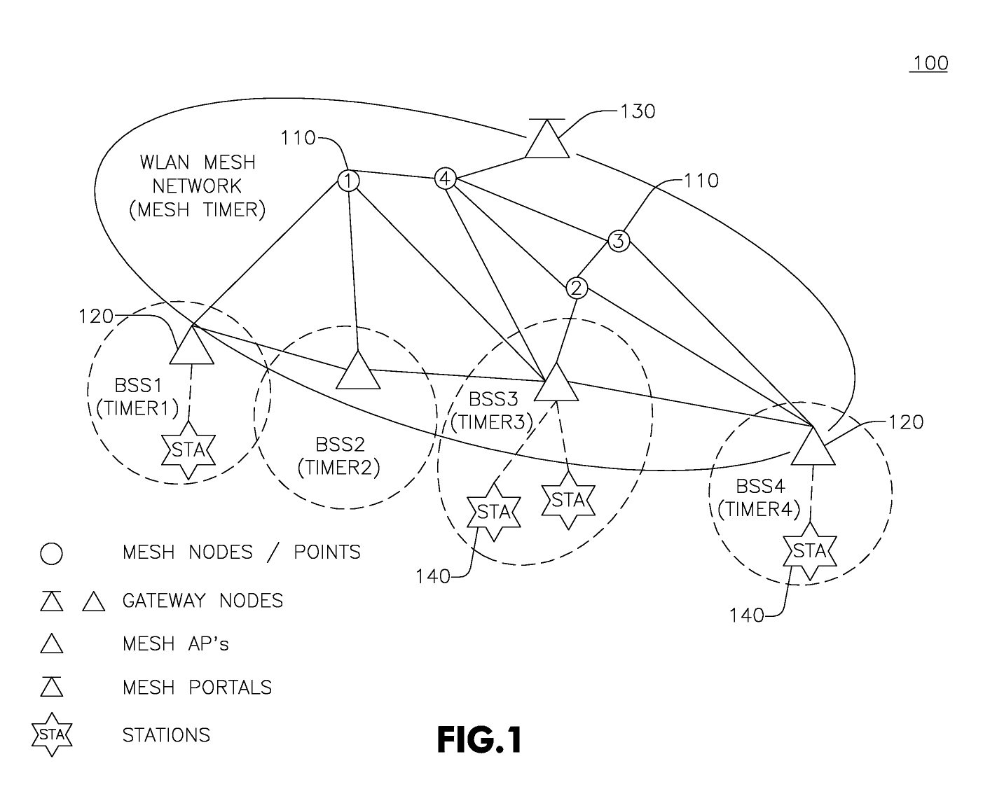

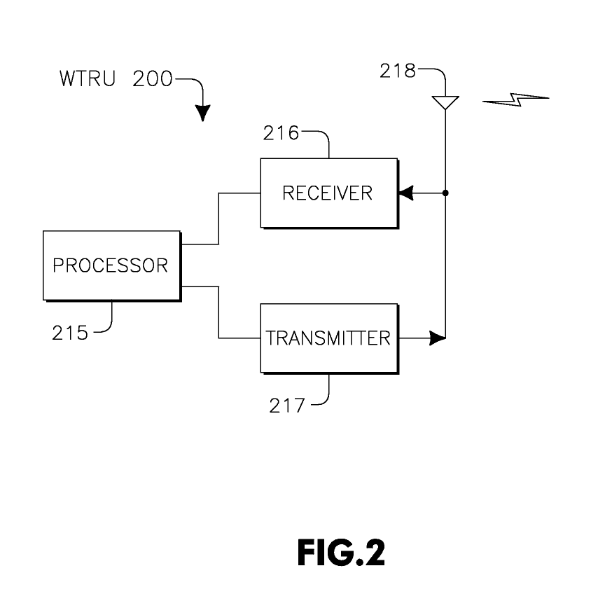

FIG. 2 is a functional block diagram of a WTRU 200 configured to coordinate timing in the WLAN mesh network of FIG. 1 in accordance with the present invention. The WTRU 200 may function as any of the devices depicted in FIG. 1, including, but not limited to, the mesh access point (MAP) 120, stations (STAs) 140, mesh points (MPs) 110, and the gateway node 130.

In addition to the components that may be found in a typical WTRU, the WTRU 200 includes a processor 215, a receiver 216, a transmitter 217, and an antenna 218. The processor 215 is configured to coordinate timing in the WLAN in accordance with the present invention. The receiver 216 and the transmitter 217 are in communication with the processor 215. The antenna 218 is in communication with both the receiver 216 and the transmitter 217 to facilitate the transmission and reception of wireless data.

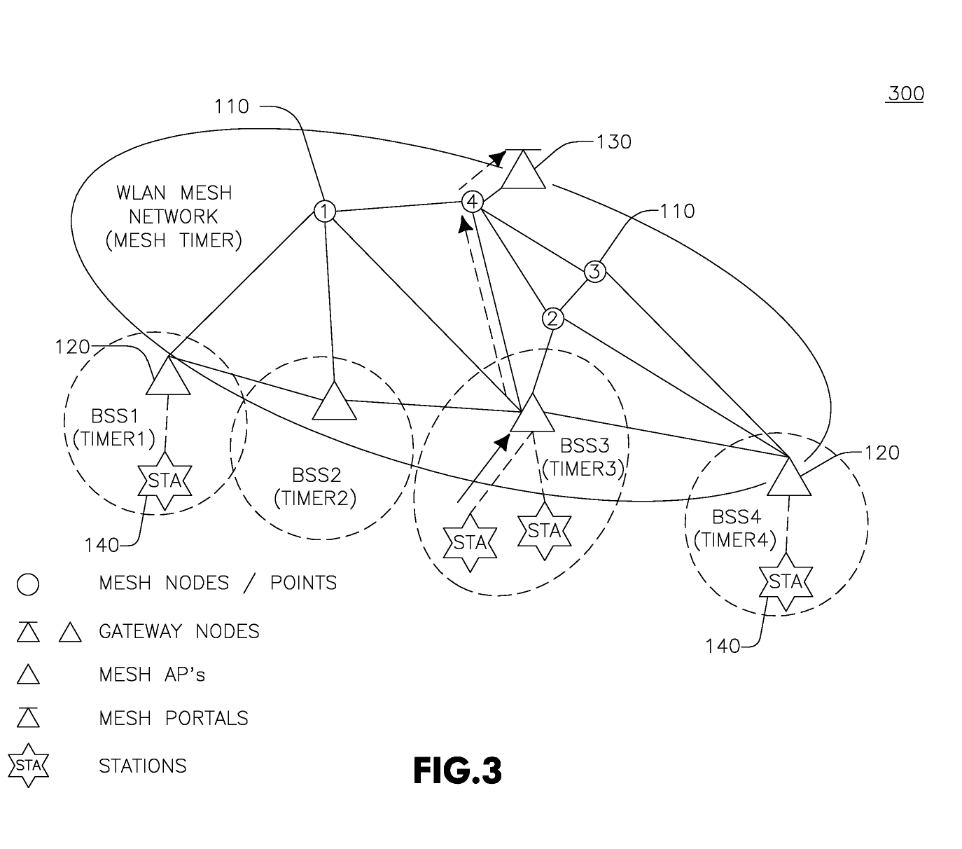

FIG. 3 shows a wireless communication system 300 containing a WLAN mesh network and a plurality of BSSs performing a method for coordinating timing in the wireless communication system of FIG. 1. The wireless communication system 300 is substantially similar to the wireless communication system 100 depicted in FIG. 1. That is, the WILAN mesh network includes a plurality of MAPs 120, MPs 110, and at least one gateway node 130. A mesh timer is associated with the mesh WLAN. In addition, each MAP 120 is also part of a BSS (designated BSS1, BSS2, BSS2, and BSS4), each of which include a BSS timer (Timer 1, Timer 2, Timer 3, and Timer 4, respectively). The BSSs also may include STAs 140. Again, although in the present example, BSS1 contains one STA 140, BSS2 contains no STAs 140, BSS3 contains two STAs 140, and BSS4 contains one STA 140, it should be noted that any number of STAs 140 may be included in any BSS. Preferably, the STAs 140 are in wireless communication with their associated MAP 120 of their respective BSSs.

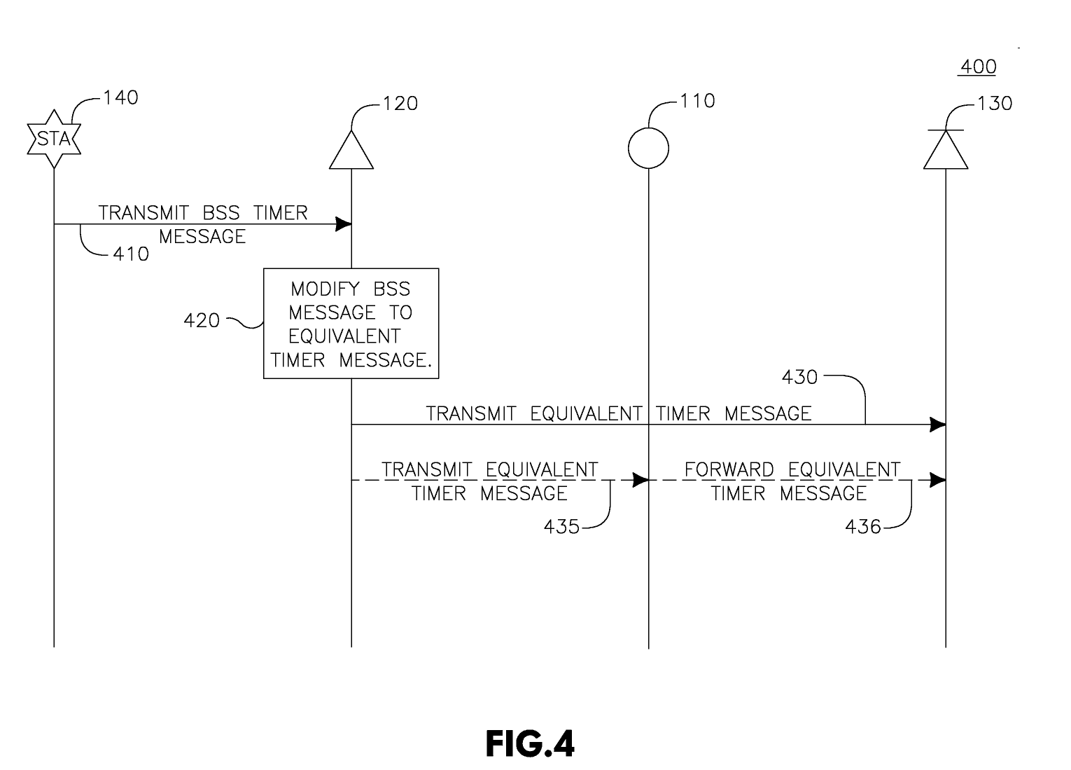

FIG. 4 is an exemplary signal diagram 400 of a STA 140, MAP 120, MP 110 and mesh portal 130 performing a method for coordinating timing in the wireless communication system 300 of FIG. 3. Although a more detailed method will be described below, in general, the STA 140 transmits a BSS timer message to the MAP 120 (410). The BSS timer message may also be referred to as a “timing” or “timestamp” message. The MAP 120 modifies the BSS timer message to an equivalent timer message (420) and transmits the equivalent timer message to the mesh portal 130 (430). If there are any MPs 110 between the MAP 120 and the mesh portal 130, then the equivalent timer message is transmitted to the MP 110 (435), which forwards the equivalent timer message on to the mesh portal 130 (436).

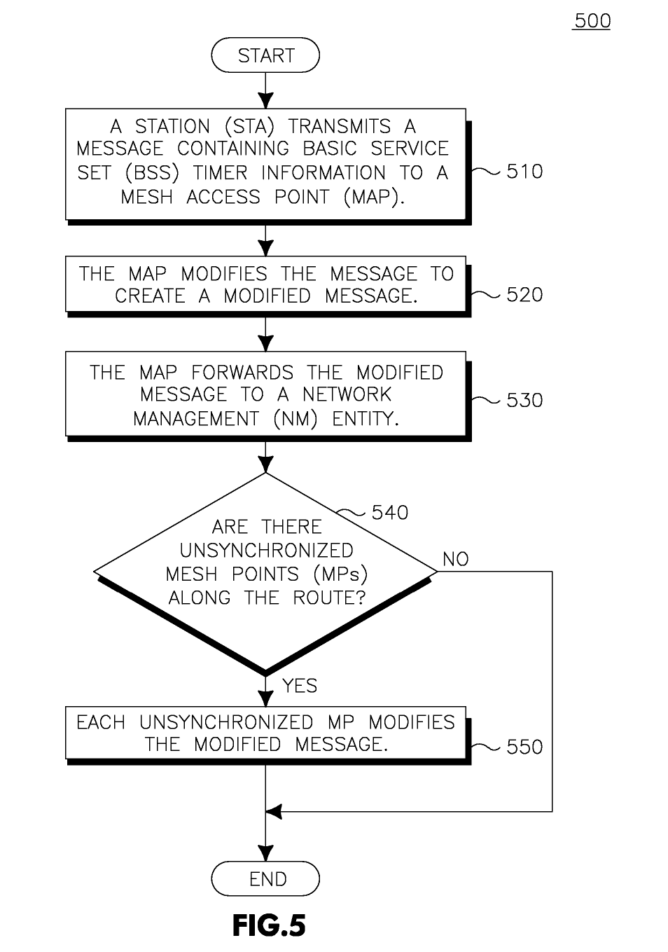

FIG. 5 is a flow diagram 500 of performing a method for coordinating timing in the wireless communication system 300 of FIG. 3. In step 510, a STA 140 transmits a message containing BSS timer information to a MAP 120. In particular, the STA 140 transmits the BSS timer information to its respective MAP 120. For example, the STA 140 in BSS 1 transmits the BSS timer information to the MAP 120 associated with BSS 1.

The MAP 120 receives the BSS timer information from the STA 140 and modifies the message to create a modified timer message (step 520). In a preferred embodiment of the present invention, the MAP 120 utilizes timer offset information to calculate the equivalent time value in terms of the mesh timer or another reference timebase. Additionally, the MAP 120 may attach additional MAP timer information, such as the mesh timer offset and the mesh timer offset drift rate, to the modified timer message. The modified message may be an extended message created by the MAP 120 based on the original message received from the STA 140, or a new message created by the MAP 120 that includes the information received from the STA 140. A new information element (IE) or, alternatively, a new information field, may be added to the original message. The equivalent timer value may also be included into an encapsulating frame. For example, the original frame and timing may be encapsulated within a mesh frame which could include the new timing information.

The MAP 120 forwards the modified message to a network management (NM) entity (step 530). In a preferred embodiment of the present invention, the NM entity is the mesh portal 130. However, the NM entity may also exist in other devices besides the mesh portal 130. If the modified message is being routed through unsynchronized MPs 110 to the NM entity (step 540), then each unsynchronized MP 110 modifies the received timer message before forwarding it to the next MP 110 or to the NM entity, in the hop (step 550).

For example, referring back to FIG. 3, the STA 140 in BSS3 transmits its BSS timer message to the MAP 120 associated with BSS3 (depicted by the solid arrow). The MAP 120 modifies the original message received from the STA 140, and forwards it to the NM entity (mesh portal 130) via MP4 (depicted by the dashed arrows). If MP4 is a synchronized MP 110, then MP4 may forward the modified message received from MAP 120 to the mesh portal 130 unaltered. However, if MP4 is unsynchronized in that it utilizes a different timebase than the mesh WLAN, then MP4 modifies the message received from the MAP 120 prior to forwarding it to the mesh portal 130.

Additionally, the reverse operation is also possible. That is, the MAP 120 may receive a timing message from the mesh WLAN, replace the mesh timer value with the equivalent BSS timer value or attach the equivalent BSS timer value to the message, then forward the message on to the STA 140. The MAP 120 may also generate a new message based on the mesh timer value and forward it to the STA 140.

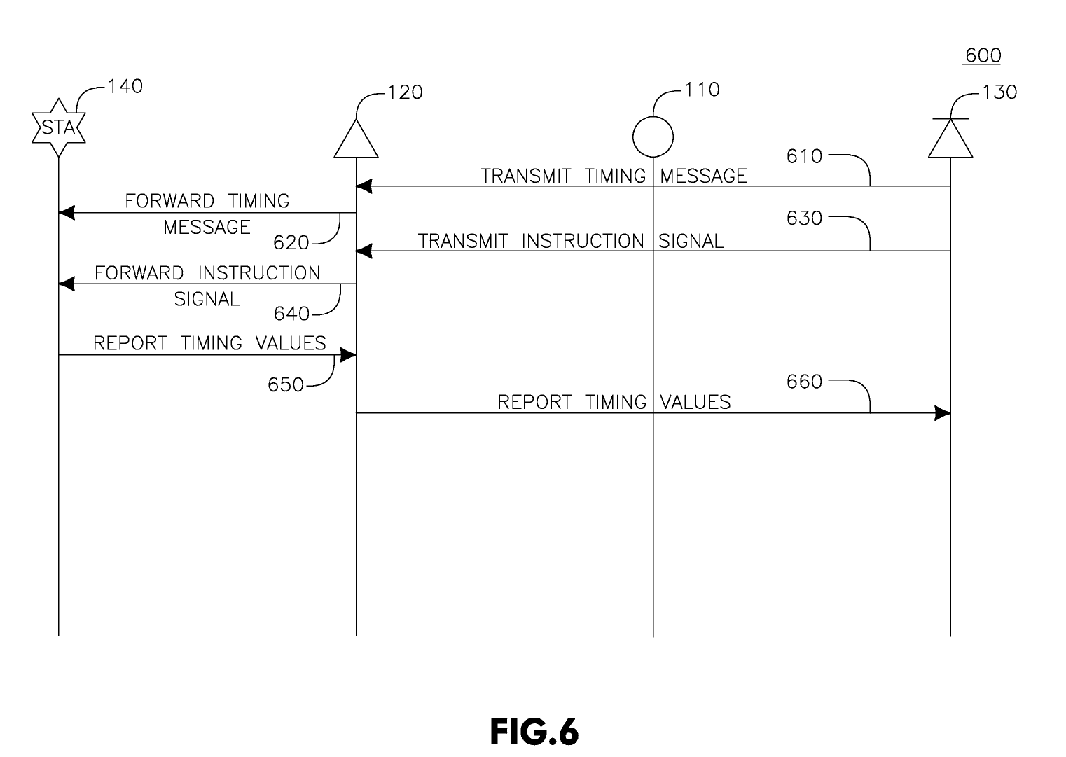

FIG. 6 is an exemplary signal diagram 600 of a STA, MAP, MP and mesh portal performing a method for coordinating timing in the wireless communication system 300 of FIG. 3, in accordance with another embodiment of the present invention. In the present embodiment, the NM entity (mesh portal 130) transmits a timing message to the MAP 120 (610). The NM entity may communicate with the MAP 120 wireless, through an MP 110, through a wired connection, or any combination thereof. The transmitted timing message contains timer values for the STAs 140.

The MAP 120 forwards the timing messages to its associated STAs 140 without modifying the timing message (620). The MAP 120 forwards this timing message irrespective of whether encapsulation or re-building of the message occurs at any intermediate forwarding points.

The mesh portal 130 transmits an instruction signal to the MAP 120 (630). The instruction signal, or polling signal, contains instructions for the MAP 120 of STA 140 to report at some time intervals BSS-mesh timing offset values or absolute timing values to facilitate the NM entity in deriving timer offsets for all MAPs 120 in the system with respect to the NM entity time base. If the instructions are intended for the STA 140, the MAP 120 forwards the instruction signal to the STA 140 (640). An absolute timing might include a timing reference obtained from an external source, such as a global positioning system (GPS).

The STA 140 reports timing values to the MAP 120 (650), and the MAP reports timing values to the mesh portal 130 (660), including the STA 140 reported timing values. Accordingly, whenever any mesh forwarded message containing timer values is received at any destination device, the destination device may request from the NM entity the current timer offset between the message source and the message destination device, and utilize the timer offset to translate received timer values into an equivalent timer value for the destination devices local time base.

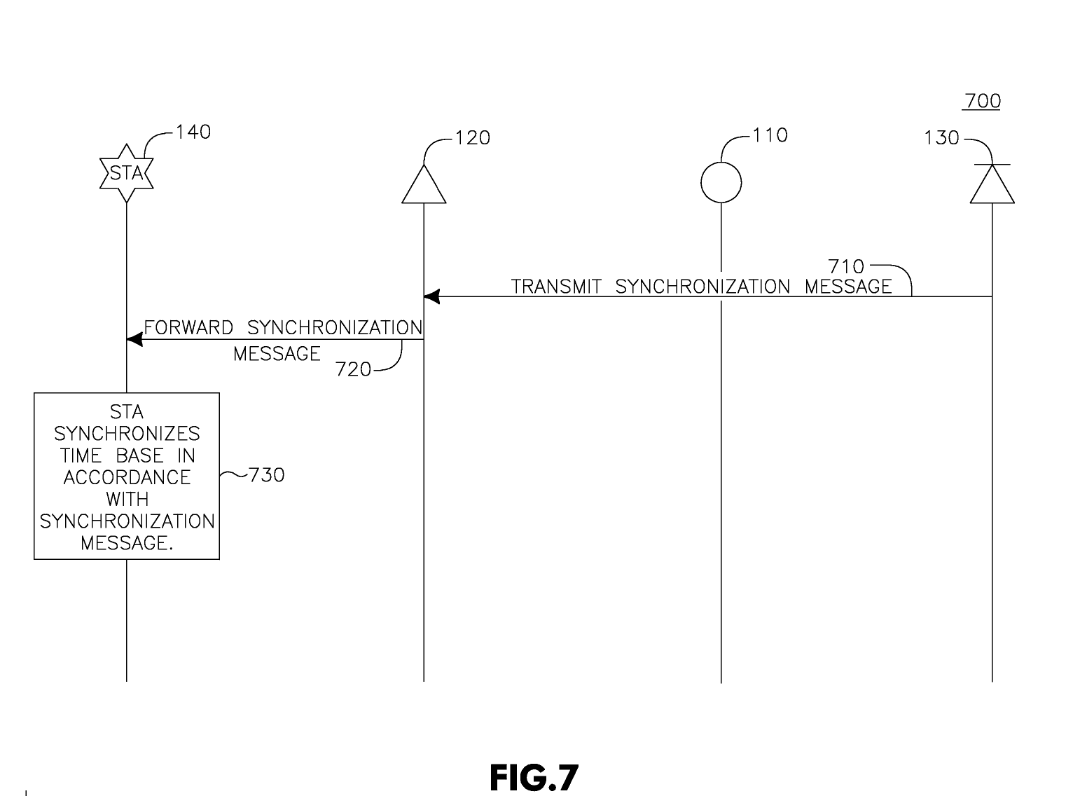

FIG. 7 is an exemplary signal diagram of a STA 140, MAP 120, MP 110 and mesh portal 130 performing a method for coordinating timing in the wireless communication system 300 of FIG. 3, in accordance with another embodiment of the present invention.

In the present example, the mesh portal 130 transmits a synchronization message to MP 110 and MAP 120 (710). The synchronization message includes a common reference clock to be used by either the whole network, or a subset of the MPs 110, MAPs 120, and STAs 140 in the network. The MAP 120 forwards the synchronization message to the STA 140 (720) and the STA 140 synchronizes its time base in accordance with the synchronization message (730).

In this manner, all devices in the system 300 may exchange messages containing timing information without performing any time translation, since the time reference is known to and is the same for all. The NM entity (mesh portal 130) periodically resynchronizes the network to minimize time base errors due to time base drift at each point in the network, preferably by transmitting another synchronization message. In addition to the synchronization message coordinating timing values in messages such as measurements, it can be used in a larger context, such as forcing all MPs 110 or STAs 140 to synchronize to the same timer.

In another embodiment of the present invention, a STA to STA timer exchange is used that is based on a time offset value. In this method, the destination device for a forwarded message that contains timer values exchanges timebase information directly with the source STA which originated the forwarded message. The timing information exchange would establish the current tier offset between source and destination STA. The variable propagation delays would be accounted for across the mesh from the source device to the destination device. Alternatively, the timer offset information could be obtained by time stamping any event which is simultaneously observable by both the source and destination devices. In one example, an external beacon or an external timing message may be received.

The signaling utilized by the STA 140, MAP 120, MP 110, and mesh portal 130 may occur via layer 2 (L2) or layer 3 (L3) frames, as well as via network management protocols such as SNMP over IP and the like. Additionally, any MPs 110 that may be along the routes between the signal sources and the signal destinations in FIG. 6 may provide intermediate routing of the signals described.

Additionally, the STAs 140, MAPs 120, MPs 110, and mesh portals 130 may include a database containing the operation status of the timing coordination feature, if this capability is supported and/or switched on. This setting may be changed remotely either through L2 or through L3 signaling frames, such as SNMP. Furthermore, devices can be configured to contain database entries which other devices in the network, or which other common reference times, may be monitored and tracked.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a station (STA) including a basic service set (BSS) timer, the STA in communication with a mesh access point (MAP), and a network management (NM) entity wherein the MAP and NM entity include a mesh timer, a method for coordinating timing, the method comprising:
(a) the STA transmitting a BSS timer information message to the MAP, wherein the BSS timer information message includes a BSS timer value;
(b) the MAP receiving the BSS timer information message and modifying the message; and
(c) the MAP forwarding the modified message to the NM entity.

2. The method of claim 1 wherein step (b) further comprises:
(d) the MAP calculating an equivalent time value; and
(e) the MAP replacing the BSS timer value with the calculated equivalent timer value.

3. The method of claim 2 wherein the equivalent time value is calculated based on timer offset information.

4. The method of claim 2 wherein the equivalent time value is calculated in terms of the mesh timer.

5. The method of claim 1 wherein the wireless communication system further comprises at least one mesh point (MP) between the NM entity and the MAP.

6. The method of claim 5 wherein the MAP forwards the modified message to the NM entity through the at least one MP.

7. The method of claim 6 wherein the at least one MP is a synchronized MP.

8. The method of claim 6 wherein the at least one MP is an unsynchronized MP.

9. The method of claim 8, further comprising the unsynchronized MP receiving the modified message and further modifying the modified message prior to forwarding it to the NM entity.

10. The method of claim 1 wherein the MAP attaches MAP timer information to the BSS timer information message.

11. The method of claim 10 wherein the MAP timer information includes the mesh timer offset.

12. The method of claim 10 wherein the MAP timer information includes the mesh timer offset drift rate.

13. The method of claim 1 wherein the modified message is an extended BSS timer information message.

14. The method of claim 1 wherein the modified message is a newly generated message.

15. The method of claim 1, further comprising the MAP:
(d) receiving a mesh timer message;
(e) modifying the mesh timer message; and
(f) forwarding the modified message to the STA.

16. The method of claim 1 wherein step (b) further comprises adding an information element (IE) to the modified message.

17. The method of claim 1 wherein step (b) further comprises including the timer value into an encapsulating frame.

18. In a wireless communication system including a (STA) including a basic service set (BSS) timer in communication with a mesh access point (MAP), and a network management (NM) entity wherein the MAP and NM entity include a mesh timer, a method for coordinating timing, the method comprising:
(a) the NM entity transmitting an instruction signal to the MAP, wherein the instruction signal includes instructions directing the reporting of timing values; and
(b) the MAP reporting timing values to the NM entity;
(c) the MAP receiving timing values and forwarding the timing values without modification; and
(d) the NM entity deriving timing offsets for the at least one MAP.

19. The method of claim 18 wherein the MAP receives timing values from the NM entity and forwards the timing values to a first STA.

20. The method of claim 18 wherein the MAP receives timing values from the STA and forwards the timing values to the NM entity.

21. The method of claim 18, further comprising the MAP forwarding the instruction signal to a first STA.

22. The method of claim 21, further comprising the first STA reporting timing values to the MAP.

23. The method of claim 18 wherein the timing values include the BSS-mesh timing offset values.

24. The method of claim 18 wherein the timing values include absolute values.

25. The method of claim 18, further comprising:
(e) a first STA transmitting a message to a second station; and
(f) the second STA requesting the current timer offset between the first STA and the second STA.

26. The method of claim 25 wherein the first STA is in a first BSS and the second STA is in a second BSS.

27. In a wireless communication system including a (STA) including a basic service set (BSS) timer in communication with a mesh access point (MAP), a plurality of mesh points (MPs), and a network management (NM) entity wherein the MAP and NM entity include a mesh timer, a method for coordinating timing, the method comprising:
(a) the NM entity transmitting a synchronization message to the MAP and the plurality of MPs, wherein the synchronization message includes information relating to a reference clock;
(b) the MAP forwarding the synchronization message to its associated STA; and
(c) the MAP, STA and plurality of MPs synchronizing their respective time bases in accordance with the synchronization message.

28. The method of claim 27, further comprising the NM entity transmitting a resynchronization message to the MAP and the plurality of MPs.

29. A mesh access point (MAP), comprising:
a receiver;
a transmitter; and
a processor in communication with the receiver and the transmitter, the processor configured to receive a basic service set (BSS) timer information message, modify the BSS timer information message, and forward the modified message to a network management (NM) entity.

30. The MAP of claim 29 wherein the processor is further configured to receive a synchronization message from the NM entity and synchronize the MAP in accordance with the synchronization message.

31. The MAP of claim 30 wherein the processor is further configured to forward the synchronization message to a STA in communication with the MAP.

32. The MAP of claim 29 wherein the processor is further configured to forward the modified message to the NM entity through an intermediate mesh point (MP).

33. The MAP of claim 29 wherein the processor is further configured to calculate an equivalent time value.

34. The MAP of claim 33 wherein the equivalent time value is based upon the mesh timer.

35. The MAP of claim 29 wherein the processor is further configured to receive an instruction signal from the NM entity and report BSS-mesh timing offset values to the NM entity.

36. The MAP of claim 35 wherein the processor is further configured to forward the instruction signal from the NM entity to the STA.

37. An integrated circuit (IC), comprising:
a receiver;
a transmitter; and
a processor in communication with the receiver and the transmitter, the processor configured to receive a basic service set (BSS) timer information message, modify the BSS timer information message, and forward the modified message to a network management (NM) entity.

38. The IC of claim 37 wherein the processor is further configured to receive a synchronization message from the NM entity and synchronize the MAP in accordance with the synchronization message.

39. The IC of claim 38 wherein the processor is further configured to forward the synchronization message to a STA in communication with the MAP.

40. The IC of claim 37 wherein the processor is further configured to forward the modified message to the NM entity through an intermediate mesh point (MP).

41. The IC of claim 37 wherein the processor is further configured to calculate an equivalent time value.

42. The IC of claim 41 wherein the equivalent time value is based upon the mesh timer.

43. The IC of claim 37 wherein the processor is further configured to receive an instruction signal from the NM entity and report BSS-mesh timing offset values to the NM entity.

44. The IC of claim 43 wherein the processor is further configured to forward the instruction signal from the NM entity to the STA.
